(19) United States
(12) Patent Application Publication
(10) Pub. No.: US 2010/0051187 A1
(43) Pub. Date: Mar. 4, 2010

(54) Method and Apparatus for Labelling

(75) Inventors: Todd Willick, Mississauga (CA); Peter Heuss, Toronto (CA); Derek Bessette, Milton (CA)

Correspondence Address: STUART WILKINSON, 833 CALDER ROAD, MISSISSAUGA, ON, L5J 2N6, CA

(73) Assignee: PCA Services Inc., Oakville (CA)

(21) Appl. No.: 12/551,470

(22) Filed: Aug. 31, 2009

(30) Foreign Application Priority Data
Aug. 29, 2008 (CA) 2639239

(51) Int. Cl. B44C 1/17; B32B 37/00; B65H 37/04

(52) U.S. Cl. 156/238; 156/60; 156/540

(57) ABSTRACT

In a method and apparatus for applying a label having an adherent coating to a package having a front and sides to stick the label to the package, the label and the package are tacked together with a predetermined relative positioning. A conformable tamp block is brought against the package to press the label against and around the package sides. The block has articulated elements which enable conformance of one element against the front of the package and articulation and constrained deformation of a second element to press the label around the sides of the package. The label is of stiff material, both to enable independent suspension of the label ready for labelling and to faciliate separation of labels from an adhering release liner.

### FIELD OF THE INVENTION

The present invention relates to a method and apparatus for labelling items to be dispensed and has particularly application to labelling items to be dispensed from a medicament dispensary kiosk.

### DESCRIPTION OF RELATED ART

In this specification, the term “medicament” encompasses drugs and any and all other materials dispensed subject to presentation of a prescription. The traditional means of dispensing prescribed medicaments involves a doctor meeting with a patient and prescribing a medicament based on a particular diagnosis, and then hand writing and signing a prescription for the patient to carry to a pharmacist at a pharmacy location for fulfillment. In recent years, two major advancements have occurred in the field of medicament dispensing. The first is the advent of electronic prescription capturing methods, systems and apparatus, which improve the overall accuracy and patient record-keeping associated with prescribing medicaments. The second is the advent of automated apparatus, typically configured as kiosks, from which medicaments can be automatically dispensed, the kiosks being located for convenient patient access, such as at a doctor's premises, a hospital or mall, and being networked with a system server for inventory control and management. In this regard, reference may be made to applicant's copending PCT application serial no. PCT/CA2007/001220 related to a method, system and apparatus for dispensing medicaments, which is specifically incorporated by reference herein.

More specifically, PCT application serial no. PCT/CA2007/001220 describes a networked system having a server, a database of patient information linked to the server, a first client having input means linked to the server and operable to generate a script for a medicament prescribed to a user, a second client comprising an automated apparatus for dispensing medicaments (referred to in said PCT application as a robotic prescription dispensary) operable to recognize a human and/or machine readable description in the script, and to provide validating cross-referencing between the description and patient information as a prelude to dispensing a medicament to the user on the basis of the input script. A doctor in a clinic can be a third client having input means linked to the server to input appropriate prescription information, or accept certain prescription information from the database as being applicable in the particular case for a particular patient. Further, the doctor's client device can be operable to display patient information, e.g., drug history, insurance coverage, etc., and a printer module can print the script as a paper print-out.

The server and database enable storing, compiling and retrieval of patient data including name, address, and diagnostic and drug history. Access to the database can be provided to both the doctor and the automated apparatus for dispensing medicaments via the server, via a secure connection, or via a link between the system and a clinic's existing clinic management system or patient database.

The apparatus in PCT application serial no. PCT/CA2007/001220 also describes a user interface, a teleconferencing or video-conferencing means enabling communication between the user and a human validation agent, and a scammg means for capturing an image of the script so that it, if needed, it can be viewed by a human validation agent, such as a licensed pharmacist communicating with the system and with the apparatus from a remote location to the apparatus, to approve a prescription. The user interface of the dispensary apparatus provides detailed and clear instructions to guide the user.

An authentication means confirms the identity of the patient, for example, by prompting for a personal identification number or by biometric means or by associating certain questions to answers provided by the patient that identify the patient to the apparatus, and cross-referencing this information with the patient information stored on the networked database. Once the patient is recognized, the dispensary apparatus prompts the user for a script and the apparatus processes the user-input script either by the above-mentioned human validation agent or by processing the machine readable description, which may be a bar code. This information can be verified with the server and the database. The apparatus may also interface with the server for the adjudication of insurance claims and for determining amounts to be paid by patients. The patient either accepts or rejects the transaction. If the transaction is accepted, the apparatus interfaces with the server in effecting a payment transaction, for example, by prompting the patient for credit card information. Prescription labels and receipts are printed. The apparatus confirms that the drug is correct and delivers it to a dispensing area for retrieval by the user while retaining the script in a lock box, and verifying that the purchased drug product has been retrieved. Further, the apparatus may print and/or provide to the user educational materials relevant to the medicaments that have been dispensed. The automated dispensing apparatus for is of significant value in enabling a patient to obtain prescribed medicaments without having to attend a pharmacy or drug store.

As described in PCT application serial no. PCT/CA2007/001220, the medicament dispensary kiosk may be located in a doctor's office or clinic. The interaction between a patient and the kiosk user interface coupled with access to the various networked functionalities means that a patient can obtain prescribed medicaments without having to attend a pharmacy or drug store.

In copending U.S. provisional patent application Ser. No. 61/170,642, which is specifically incorporated by reference herein, there is described a particular medicament dispensary apparatus for delivering medicament packages to users. Such packages may take the form of bottles, boxes, shrink wrap foil containers, etc., and therefore can be of a range of shapes and sizes. As previously indicated, each package has to be labelled. It would be of value to have a labelling apparatus and method, which are versatile in the sense of being applicable to such a range of package shapes and sizes.

For medicament dispensing kiosks, medicament package labels are typically of a standard shape and size to enable them to be passed through a printer, and must contain critical patient and medication information in conformance with industry standards and offering little scope for variation in shape, size or materials. Such labels are typically applied by running pressure sensitive adhesive back coated labels on a peal-away carrier through a label printer and transferring the printed label to the medicament container such as a bottle or box. Known label transfer methods have used sponges, vacuum, sponges and vacuum in combination, transfer media, transfer roller and pressure pads. There is a need for reliable accurate placement and adhesion of standard flat labels to dispensed medicament products.

According to one aspect of the invention, there is provided a method of applying a label having an adherent coating to a package having a front and sides to stick the label to the package, the method comprising bringing the label and the package together so that the label contacts the package to establish a tacking contact at a predetermined position of the label relative to the package, and effecting a relative movement of a conformable tamp block against the label and package to apply the label to the package, the tamp block having a first element articulated to a second element, a first part of the movement of the tamp block effective to sandwich a first area of the label between the first element of the tamp block and the front of the package, a second part of the movement effective to articulate the second element relative to the first element to a position adjacent a side of the package and to deform the second element against a second area of the label to fold said second area against a side of the package and to sandwich the second area between the second element of the tamp block and the side of the package.

Preferably, in the second part of the movement, deformation of the second element is constrained by a constraining member whereby to direct said movement of the second element against said second area of the label. The constraining member can be fixed to the tamp block or can alternatively be mounted to an external frame. The tamp block can be of a general of U form, the first element of the tamp block being a cross piece of the U and the second element of the tamp block being uprights of the U. Preferably the first part of the movement and the second part of the movement occur successively as a single unidirectional movement of an actuator mechanism attached to the tamp block.

The method can further comprise bringing the label to the package from a reel of labels self adhering to a liner by passing the liner around a roller, the label having a stiffness greater than a stiffness of the liner, whereby, on passage of the liner around the roller, the difference in stiffness acts to overcome adherence between the label and the liner and to release the label from the liner. Preferably the stiffness of the label is sufficient to suspend the label in a predetermined position in the course of the release, to permit said bringing of the label and the package together so that the label contacts the package to establish said tacking contact at said predetermined position of the label relative to the package.

According to another aspect of the invention, there is provided apparatus for applying a label having an adherent coating to a package having a front and sides to stick the label to the package, the apparatus comprising a supply reel of label stock having labels adhering to a liner, first transport mechanism to bring labels to a printing zone and to a labelling zone and to bring containers to the labelling zone, the transport mechanism operable to bring a package and a label together so that the label contacts the package to establish a tacking contact at a predetermined position of the label relative to the package, the apparatus further including a second transport mechanism to effect a relative movement of a conformable tamp block against the label and package to apply the label to the package, the tamp block having a first element articulated to a second element for sandwiching a first area of the label between the first element of the tamp block and the front of the package, the tamp block having a second element movable relative to the first element for location adjacent a side of the package, the second element deformable to sandwich a second area of the label between the second element of the tamp block and a side of the package.

Preferably, the apparatus includes a constraining member to direct movement and deformation of the second element to apply pressure to the second area of the label sandwiched between the tamp block and the side of the package, with the constraining fixed to a stationary frame and also attached to the conformable tamp block. The first transport mechanism can be operable to bring the label to the package from a reel of labels self adhering to a liner by passing the liner around a roller, the roller adapted for operation with a label having a stiffness greater than a stiffness of the liner, whereby, on passage of the liner around the roller, the difference in stiffness acts to overcome adherence between the label and the liner to release the label from the liner. The first transport mechanism can be further operable to bring the label to a labelling zone and to suspend the label in a predetermined position in the course of the release, to permit said bringing of the package to the label to establish said tacking contact at said predetermined position of the label relative to the package.

### BRIEF DESCRIPTION OF THE DRAWINGS

For simplicity and clarity of illustration, elements illustrated in the following FIGs are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various FIGs, and wherein:

FIG. 1 is a side view of a labelling unit according to one embodiment of the invention;

FIG. 2 is a front perspective view from above of the labelling unit of FIG. 1;

FIG. 3 is a partial side view of part of a medicament dispensary kiosk showing the labelling unit of FIG. 1 mounted with a frame of the kiosk;

FIG. 4 is a front view of part of the unit of FIG. 1 to a larger scale;

FIG. 5 is a perspective view of a tamp block used in a method according to one embodiment of the invention; and

FIGS. 6 to 8 show a sequence in the operation of the tamp block of FIG. 5.

### DETAILED DESCRIPTION OF THE INVENTION INCLUDING THE PRESENTLY PREFERRED EMBODIMENTS

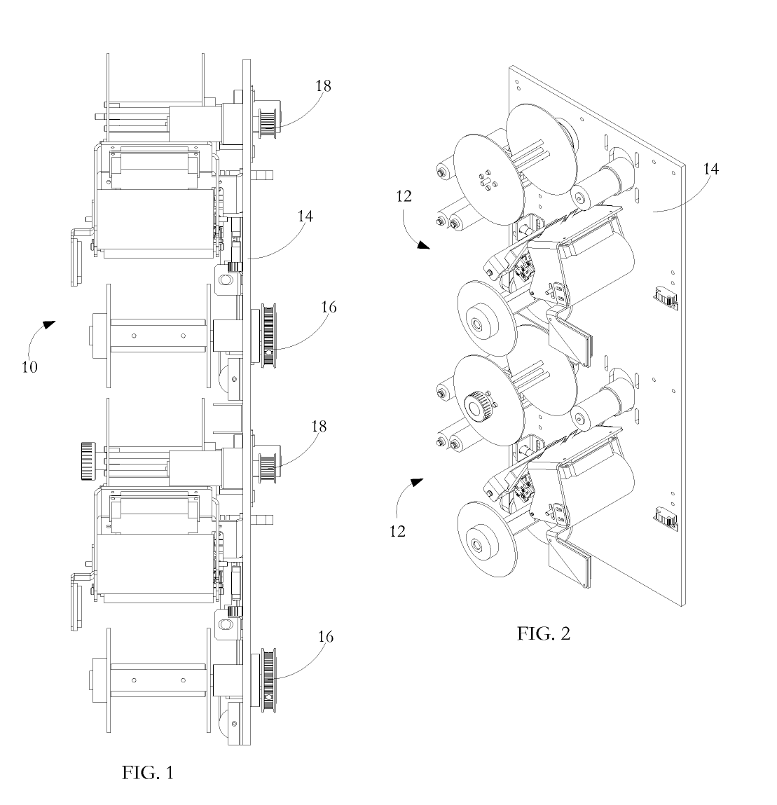

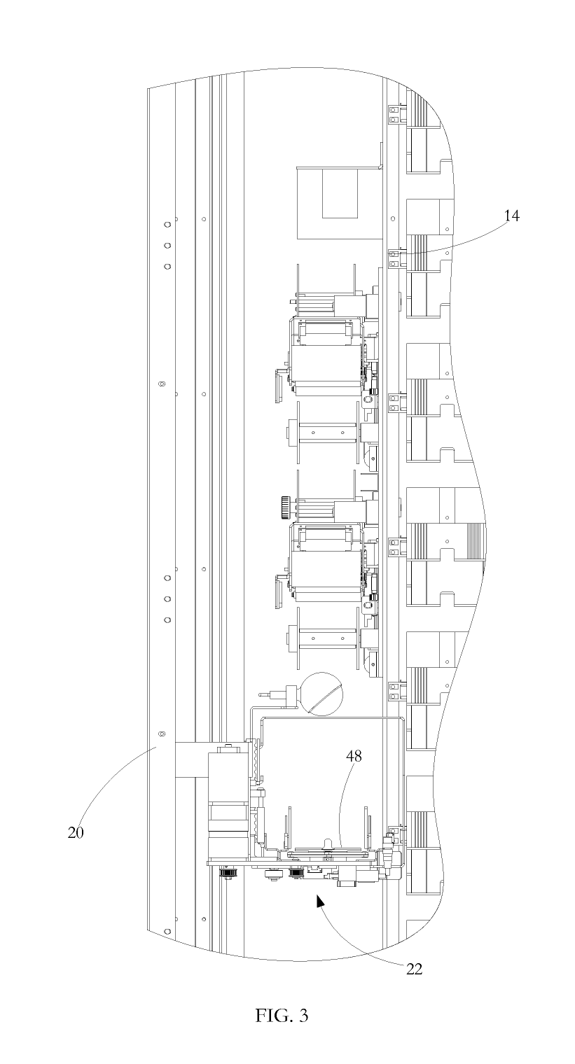

Referring in detail to FIGS. 1 and 2, a package labelling unit 10 is shown which has upper and lower labelling modules 12. In normal mode, one of the modules is in use and the other module is redundant pending breakdown or other interruption in operation of the one module. Elements of the labelling modules 12 are mounted on a mounting plate 14. As shown in FIG. 1, rotatable elements of the labelling module are fixed to pulleys 16 which are mounted on a reverse face of the mounting plate and are driven by bands (not shown) from a motor 18. As shown in FIG. 3, the labelling unit 12 is mounted within a support frame 20 of a medicament dispensing kiosk. Also mounted in the frame is a pick head 22 of the sort described in copending U.S. patent application Ser. No. 12/503,989, which is herein specifically incorporated by reference.

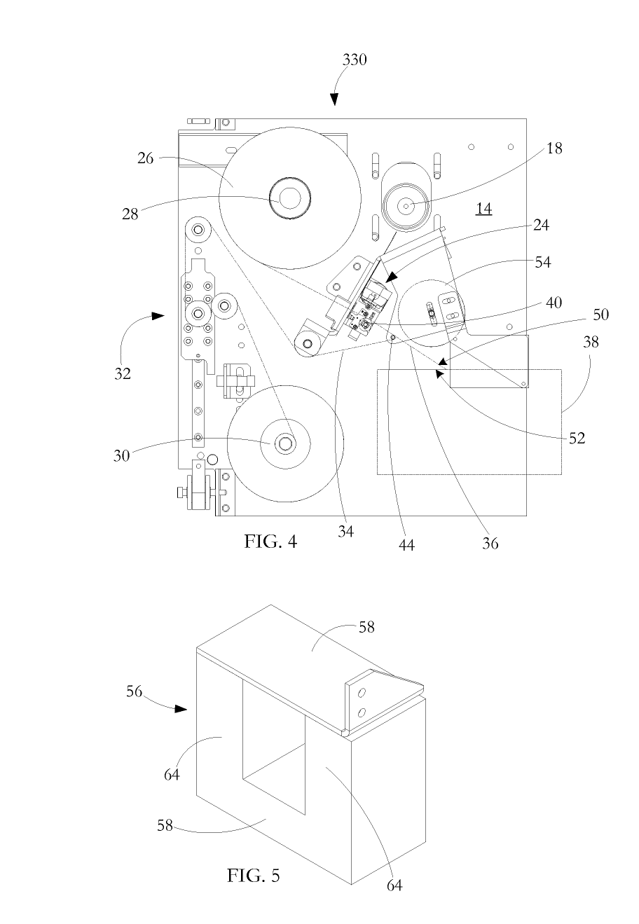

As shown in greater detail in FIG. 4, each labelling module 12 has a printer 24, label stock 26 wound from a supply reel 28, a take-off reel 30 associated with a tensioner device 32, and the motor 18. The label stock 26 is in the form of a release liner or backing 34, with labels 36 self-adhering to the liner along its length.

The labelling module is used to apply a label to a medicament product container or package 38 which is transported to the labelling module 12 using the pick head 22. In use, label stock 26 is pulled off the supply reel 28 by a drive wheel 40 in the printer 24. Within the printer, the label stock is halted and desired medicament identifying data is printed onto a presented label before the printer wheel 40 further advances the label stock 26 in preparation for the printed label 36 to be applied to the container 38. The label can alternatively be printed while still in potion as is known in the art. As the label stock 26 exits the printer 24, the printed label 36 continues to adhere to liner 34, and the take-up reel 30 and tensioner device 34 pull the liner around a small diameter roller 44 so as to take up the liner 34 at a rate related to the throughput of the printer 24.

The label 36 is made from paper or plastic that is stiffer than the liner 34 to which it adheres on the supply reel 28. This results in the label 36 separating from the liner 34 as a result of its movement around the small diameter roller 44. The label 36 is also sufficiently stiff that it adopts a suspended position as shown in FIG. 4 as it progressively separates from the liner 34. For this purpose, the label 36 is of material that is sufficiently stiff as effectively to prevent the label from sagging under its own weight from edge to edge along its longest side. The label stock 26 advances to a point where about ⅞ of the label length is detached from the liner 34 so that the label is suspended in preparation for a subsequent stage in the labelling process. It will be appreciated that whereas, in this preferred embodiment, the label 36 is of uniform stiffness over its area, in an alternative embodiment, the label can be locally stiffened as, for example, by one or more thicker regions, whereby the stiffness required both for the separation from the liner and for the temporary suspension of the label are achieved.

The pick head 22 is then driven to pick a medicament container 38 to be dispensed by the apparatus and to raise the container to a desired level where a platen 48 forming part of the pick head and supporting the container moves in a horizontal direction to bring the container to the position shown in FIG. 4. At this point, the container is located under the suspended label 36 with a combination of sensors and feedback ensuring that a front edge 50 of the label is aligned with a pre-selected contact start point 52 on the product package.

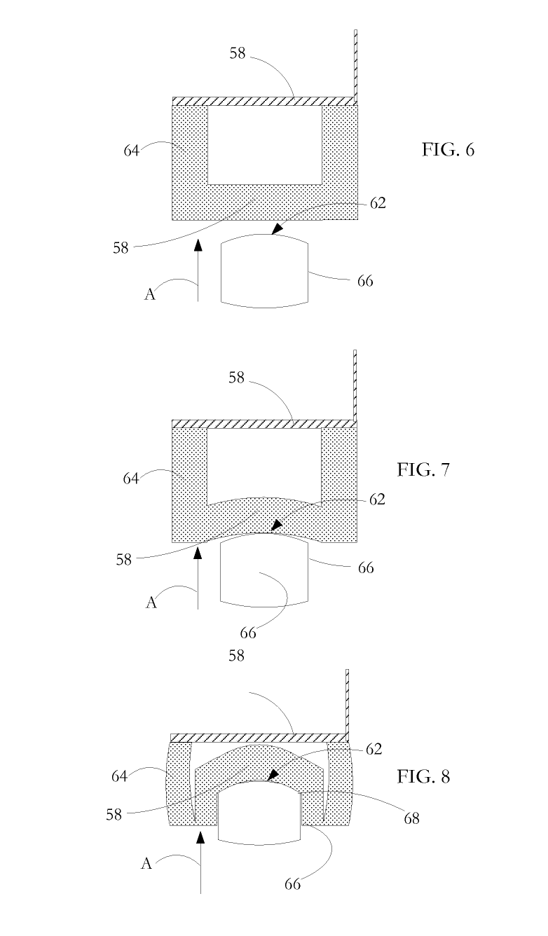

In a subsequent stage of the labelling process, the pick head 22 drives the package upwardly against a conformable cylindrical tamp block 54 of polyurethane foam, this movement acting both to initiate a “tacking” of the self-adhesive label 36 to the package 38 and to dislodge the last part of the suspended label 36 from the liner 34. In an alternative embodiment, the “tacked” label is removed from the liner by moving the package horizontally in synchronism with movement of the printer wheel 40. The medicament container 38, with label attached, is then further raised by the pick head 22 to bring the container with the label side up, into contact with a second tamp block 56 formed from conformable polyurethane foam, the second tamp block being shown in FIG. 4 and in FIGS. 6 to 8. The tamp block 56 is generally of U shape and has a rigid constraining bar 58 mounted to the mounting plate 14 and extending between and fixed to the two uprights of the U.

In use, the package container 38 with label 36 tacked to at least a central part of the container surface is brought against a cross-piece 60 of the U tamp block as shown in the operational sequence of FIGS. 6, 7 and 8. The uprights of the U are anchored by the constraining bar 58 and the cross-piece 60 of the U is relatively thin and flexible. Consequently, when the product container 38 is moved in the direction of arrow A, the relatively thin and flexible U cross-piece firstly conforms to an upper surface 62 of the package container 38 as shown in FIG. 7 so that a part of the label is sandwiched between the cross-piece 60 and the front of the package. Then, in response to further upward movement of the platen 48 in the direction of arrow A, as shown in FIG. 8, the tamp block 56 is squeezed resulting in U uprights 64 being forced alongside container sides 66. Because the U uprights 64 are prevented from further translational movement, they buckle and fold as shown in FIG. 8 and, in so doing, deform to embrace at least a part of the respective sides of the package container so as to fold the label edges into adhering contact with both the sides 66 and corners 68.

Dimensions and materials are selected so as to direct pressure to contact the label to all intended parts of the package and to apply sufficient pressure to activate the contact sensitive adhesive. Because the size and shape of the package are known to the pick head control means, accurate label placement is possible with this method, with high reliability and repeatability.

It will be appreciated that the first and second tamp blocks, 54 and 56 respectively, can be combined if desired, whereby a first part of the movement of the container 38 relative to the combination tamp block is to tack the label 36 to the package, and then a subsequent part of the movement is to effect the label wrapping and application described previously. It will be appreciated also that alternatives to the U form of tamp block are possible. Thus O-form and H-form blocks can, for example, be configured to provide the relative translational movement and the block deformation to apply the label to the front and sides of a package.

In addition, while, conveniently, the tamp block is formed of a single cut or moulded piece of material, the parts of the tamp block that are used respectively for the front tamp and the side tamp can be separate but joined by a mechanical articulation. It will be appreciated that in the preferred embodiment, the movement of the product container relative to the tamp block to apply an adherent label to the front and sides of a package is a single unidirectional movement of the container. However, the movement can alternatively be affected as intermittent actions. For example, a first translational movement of the tamp block or container to apply a label to the front of the package can be followed by a second movement where a combination of translational movement and twisting are used to apply parts of the label against the side walls.

In addition, it will be realized that the movement need not be unidirectional in nature. In a further alternative arrangement, the tamp block is moved while the product container, is maintained in a fixed position for the label application, or both the tamp block and the container are moved to effect the label application. It will be further appreciated that whereas the nature of the deformation of the tamp block to effect the pressure against the sides of the container occurs by the tamp block being squeezed between a clamping fixture at one side of the tamp block and the medicament package at the other side of the tamp block, other external fixtures can be positioned so as to limit the locations into which parts of the tamp block can be deformed to those required for the effective application of the label where required on the container and to the effective application of pressure at the contact locations.

Other variations and modifications will be apparent to those skilled in the art. The embodiments of the invention described and illustrated are not intended to be limiting. The principles of the invention contemplate many alternatives having advantages and properties evident in the exemplary embodiments.

What is claimed is:

1. A method of applying a label having an adherent coating to a package having a front and sides to stick the label to the package, the method comprising bringing the label and the package together so that the label contacts the package to establish a tacking contact at a predetermined position of the label relative to the package, and effecting a relative movement of a conformable tamp block against the label and package to apply the label to the package, the tamp block having a first element articulated to a second element, a first part of the movement of the tamp block effective to sandwich a first area of the label between the first element of the tamp block and the front of the package, a second part of the movement effective to articulate the second element relative to the first element to a position adjacent a side of the package and to deform the second element against a second area of the label to fold said second area against a side of the package and to sandwich the second area between the second element of the tamp block and the side of the package.

2. A method as claimed in claim 1, wherein in said second part of the movement, deformation of the second element is constrained by a constraining member whereby to direct said movement of the second element against said second area of the label.

3. A method as claimed in claim 2, wherein the constraining member is fixed to the tamp block.

4. A method as claimed in claim 3, wherein the constraining member is mounted to a frame.

5. A method as claimed in claim 3, the constraining member being a generally rigid bar.

6. A method as claimed in claim 1, the tamp block being generally of U form, the first element of the tamp block being a cross piece of the U and the second element of the tamp block being an upright of the U.

7. A method as claimed in claim 1, the block having a pair of such second elements actuable against respective sides of the package.

8. A method as claimed in claim 1, the first part of the movement and the second part of the movement together comprising a single unidirectional translational movement.

9. A method as claimed in claim 1, the first element being sufficiently flexible to permit conformance of the second element to a shaped front of the package in the course of the first part of the movement.

10. A method as claimed in claim 1, the method further comprising bringing the label to the package from a reel of labels self adhering to a liner by passing the liner around a roller, the label having a stiffness greater than a stiffness of the liner, whereby, on passage of the liner around the roller, the difference in stiffness acts to overcome adherence between the label and the liner and to release the label from the liner.

11. A method as claimed in claim 10, further comprising using the stiffness of the label to suspend the label in a predetermined position in the course of the release, to permit said bringing of the label and the package together so that the label contacts the package to establish said tacking contact at said predetermined position of the label relative to the package.

12. Apparatus for applying a label having an adherent coating to a package having a front and sides to stick the label to the package, the apparatus comprising a supply reel of label stock having labels adhering to a liner, first transport mechanism to bring labels to a printing zone and to a labelling zone and to bring containers to the labelling zone, the transport mechanism operable to bring a package and a label together so that the label contacts the package to establish a tacking contact at a predetermined position of the label relative to the package, the apparatus further including a second transport mechanism to effect a relative movement of a conformable tamp block against the label and package to apply the label to the package, the tamp block having a first element articulated to a second element for sandwiching a first area of the label between the first element of the tamp block and the front of the package, the tamp block having a second element movable relative to the first element for location adjacent a side of the package, the second element deformable to sandwich a second area of the label between the second element of the tamp block and a side of the package.

13. Apparatus as claimed in claim 12, further comprising a constraining member to direct movement and deformation of the second element to apply pressure to the second area of the label sandwiched between the tamp block and the side of the package.

14. Apparatus as claimed in claim 13, wherein the constraining member is fixed to the tamp block.

15. Apparatus as claimed in claim 13, wherein the constraining member is mounted to a frame.

16. Apparatus as claimed in claim 12, wherein the first transport mechanism is operable to bring the label to the package from a reel of labels self adhering to a liner by passing the liner around a roller, the roller adapted for operation with a label having a stiffness greater than a stiffness of the liner, whereby, on passage of the liner around the roller, the difference in stiffness acts to overcome adherence between the label and the liner to release the label from the liner.

17. Apparatus as claimed in claim 16, wherein the first transport mechanism is operable to bring the label to a labelling zone and to suspend the label in a predetermined position in the course of the release, to permit said bringing of the package to the label to establish said tacking contact at said predetermined position of the label relative to the package.
